(19) United States
(12) Patent Application Publication
(10) Pub. No.: US 2012/0209525 A1
(43) Pub. Date: Aug. 16, 2012

(54) METHOD FOR GEO-ELECTRICAL PROSPECTION

(76) Inventors: Georgiy Mikhaylovich Trigubovich, Novosibirsk (RU); Marina Gennad'evna Persova, Novosibirsk (RU); Yuriy Grigor'evich Soloveychik, Novosibirsk (RU)

(21) Appl. No.: 13/500,024

(22) PCT Filed: Feb. 24, 2010
(86) PCT No.: PCT/RU10/00081

§ 371 Date: Apr. 3, 2012

(30) Foreign Application Priority Data
Oct. 6, 2009 (RU) 2009137048

(51) Int. Cl. G06F 19/00; G01V 3/04; G01V 3/12

(52) U.S. Cl. 702/2

(57) ABSTRACT

A geophysical method for searching and prospecting minerals is based on the 3D inversion of electrical prospection data. The conductivity of a medium is determined based on the measurement results on a basic observation system, generating a preliminary 3D model based such data carrying out a 3D calculation and calculating the offset relative to the measured data while excluding irregularities and selecting 3D objects having epicenters located under points of the basic observation system. This results in a precise 3D mode locating conductivity anomalies. Further measurements along the profiles extending through centers of the isolated anomalies can be effected, and used to correct the existing 3D model after which the presence of conductivity anomalies is confirmed or rejected and the parameters thereof are determined. The dimensions of the anomalies can be estimated and measurements made based thereon to obtain final geo-electrical 3D model of the medium being studied.

A method for geoelectrical prospecting wherein an electromagnetic field is excited in a geological medium, and an electromagnetic response to a probing signal is registered by a system of dipole sensors of electromagnetic field is disclosed in prior art (patent RU No. 2213982, G01V3/02. Said sensors are arranged on the surface of the observed area of a geologic profile with coordinate binding in relation to the source of the probe signal in the circle having a diameter which is not less than the depth Z_{f} of observing in the shape of two-dimensional grid with spacing h≦Z_{f} along and across the orientation direction of one of the electric field horizontal components in the observed zone.

In this case sensors are oriented parallel to the horizontal component of the electromagnetic field. All sensors receive an electromagnetic response to the probe signal simultaneously. The received signals are decomposed into frequency spectra, and the spectral components are multiplied by weighting coefficients derived from the corresponding expression. Multiplied values of individual spectral components from all receiving dipole sensors are summed up algebraically for obtaining resulting spectrum of the signal of the whole system. Then the inverse Fourier transform of this spectrum is done for obtaining a resultant signal of the electromagnetic response of the system of receiving dipole sensors of the electromagnetic field. This signal is used for forming an idea about the structure of the geological section. The disadvantage of this method is very complicated system of observation, difficulty in implementing the technology in the field, and the subsequent separate analysis of obtained area data, which does not fully take into account quantitatively irregularities in the host environment, and ultimately leads to an erroneous prediction.

A method of 3D marine electrical prospecting for oil is disclosed in prior art. The method includes exciting an electromagnetic field, recording signals of the electric field by receiving dipoles, obtaining information about changes in the electric field when exciting rocks by a generating dipole, modeling the profile of these rocks, and preparing a report on prediction of some minerals (patent RU 2356070, G01V3/08).

The method involves movement of the generating dipole perpendicularly to the observation profile through the center of one of the spacing of the observation profile close to the center of the observation area, and formation of areal system of measurement profiles. One-dimensional inversion is carried out for each of the measurement profiles, and a three-dimensional geoelectrical model of the environment, in which anomalies are used for deciding on the presence or absence of hydrocarbon deposits is generated. The disadvantages of this method are due to the fact that the final three-dimensional model is generated as a result of one-dimensional inversion, which does not take into account the limited size of the irregularities, which can lead to significant distortion of their parameters (position depth and conductivity). In addition, the method does not account for the effect on the results of side irregularities, which may lead to false geoelectrical conductivity anomalies or lack of significant conductivity anomalies in the model, and ultimately, to the wrong geophysical prediction.

A method and system of electromagnetic exploration and recognition of minerals (U.S. Pat. No. 7,324,899, G 01 V 3/12) is disclosed in prior art. Said method of electromagnetic exploration involves receiving electromagnetic signals by receivers located on the observation area for measuring data, determining effective complex conductivity of the medium using a 3D inversion of electromagnetic data, conversing the conductivity in a reconstructed model of the conductivity as a function of position and frequency (or time) using a theoretical multiphase physico-mathematical model, and defining geometrical parameters of the identified irregularities. This method allows inverting the EM data to obtain three-dimensional model of conductivity of the observed medium. However, this method does not provide for targeted actions to ensure the separation of the effect of shallow side irregularities, which probably lie inside the observed area, which can lead to incorrect prediction even when using the EM inversion.

The closest to the technical nature of the claimed method is a method of geoelectrical prospecting in which separation of the vector of the of transient electromagnetic field signal from the search object is carried out, said object being covered with a non-uniform screening formations (RF patent No. 1760873, G01V3/00, prototype). The known method is based on the adjustment of the full vector of the electromagnetic field by subtracting a component associated with the upper part of the section and determination of the direction to the epicenter of the sub-screen search object. For each fixed time horizontal receiving sensor determines the direction along which the field strength is maximum by sequentially changing the orientation. Then the horizontal component of the total vector H(t) is characterized by the maximum received intensity and the selected direction. According to the results of the measurements in non-central points, the distribution of the longitudinal conductivity of shielding the upper part of the section is determined. Then, for the central point, the horizontal component Hₒᵣ (t) of the normal vector H₀(t) due to the screen of the top part of the section is modeled for the entire range of recorded time. Physical modeling using the electro-physical models as well as mathematical modeling based on the calculation of the distribution of eddy currents in the non-homogeneous conductive film reflecting the particular structure of the upper part of the section is used. The next step is introducing correction of the horizontal component of the full vector in the entire range of the time. The resulting difference vector ΔH(t) obtained by vector subtraction is located in the plane of measurement and indicates the corrected direction to the search object, stabilizing over the transient period in the direction of the ore body epicenter. After that the entire unit is moved in the direction coinciding with the most stable direction of the difference vector ΔH(t) in the information field of the times, i.e. beyond the earlier times. Movement followed by a cycle of measurement and processing is repeated until the sign of the difference vector changes. Position of the epicenter of the ore body is judged by the position of sensing points, within which there is the change of the difference vector sign.

The principal drawback of this method is that in it the most contrasting conductivity objects are predominantly localized. However, if there are several objects of comparable size and depth, the change in the sign of the difference vector can occur between these objects aside from their projections to the surface. In addition, the use of physical modeling and approximate mathematical models, on the one hand, makes it difficult to interpret, but on the other hand did not allow accurately assessing the contribution of the upper part of the section in the whole informative time region of the search objects manifestation, which can lead to inaccurate localization of the search object and the unreliability of the geophysical prediction.

The purpose of the claimed invention is to improve the reliability of the geophysical prediction.

The technical result of the invention is the division of influence of lateral and depth irregularities on the results of measurements based on 3D-inversions of geoelectrical data.

The technical result is achieved due to the fact that in the method of geoelectrical prospecting comprises:

the excitation of the electromagnetic field in the geological medium,

the synchronous registration of the components of the electromagnetic field by the receiving sensors,

the definition the conductivity study of the geological medium based on the results of the base observation system;

the comparison of the measured and calculated values of the components of the secondary electromagnetic field with formation of a geoelectrical model of the researched medium;

conducting additional measurements in view of the comparison results;

the comparison of measured and calculated values of the secondary electromagnetic field component with the formation of a geoelectrical model of the research medium is accomplished by forming a 3D models, for which the 3D calculation and calculation of a mis-tie concerning the measured values deleting false conductivity anomalies and selecting 3D objects with epicenters under at the basic observation system;

using the obtained amended 3D model, the location of conductivity anomalies in the target horizon is determined, after that additional measurements are taken along the profiles passing through the centers of conductivity anomalies for determining mis-tie of said additional profiles for the corrected 3D model, which is adjusted according to the level of the mis-tie, and as a result, confirming or rejecting the presence of conductivity anomalies in the target horizon, and then determining the parameters of all detected anomalies in the conductivity using the data of the base observation system and the additional measurements that have a significant impact on evidence time of target objects at the points of the base observation system or at the points of additional measurements;

estimate the transverse size of the conductivity anomalies, and in case of its significant influence on times corresponding to evidence of the target objects at the points of the base observation system or at the points of additional observation system P *taking measures along the profiles passing through the centers of these conductivity anomalies; after that 3D inversion is carried out using data of the obtained observation system including the base observation system and executed additional profiles of measurements, carried out 3D inversion and on its basis the final geoelectrical 3D model of the medium being studied is obtained. This model is used for determining geometrical parameters, conductivity and positioning of conductivity anomalies in the whole horizon. Said additional measurements are preferably carried out until all conductivity anomalies isolated under the points of the base observation system in the target horizon are contoured, or until conductivity anomalies isolated in the upper horizons in relation to the target one under the points of the corresponding additional measurements are contoured.

The additional measurements are carried out with a change in location of the receivers without changing the positions of the excitation sources, as well as with a change in the location of the receivers as well as of the excitation sources.

The base observation system can be profiled with coaxial probes or areal with coaxial probes.

The base observation system can also be profile with multi-spacing observation performed along one direction or a profile-areal along several quasi-orthogonal directions or along a few parallel or radial directions.

The base observation system can also be areal with multi-spacing observations performed on a regular observation network within the study area along a few parallel or radial directions, or along a random irregular observation network.

The technical result is achieved by the fact that the excitation source is a loop source, and measurements are carried out using inductive receiving sensors, wherein the excitation source and receiving sensors are located in one plane or at different altitude levels with respect to the depth of the search object.

In addition, the excitation source can be an electrically grounded horizontal line, and the measurements can be done with the help of electrically grounded lines collinear to the excitation source.

The excitation is carried out using a source being a vertical electric line or some analogs, wherein the measurements are taken using induction sensors or electrically grounded lines.

When the electromagnetic field is excited by a loop source or source in the form of an electrically grounded horizontal or vertical electric line or its analogs, 3 components of the magnetic field and 2 horizontal components of the electric field are measured.

What is more, the method can include measuring magnetotelluric field (magnetotelluric observation) by measuring 3 components of the magnetic field and 2 horizontal components of the electric field.

The invention is illustrated by the following figures:

In addition to carrying out the method can be measured magnetotelluric field of the earth (magnetotelluric observation) by measuring the 3 components of the magnetic field and 2 horizontal components of the electric field.

The invention is illustrated by the following drawings:

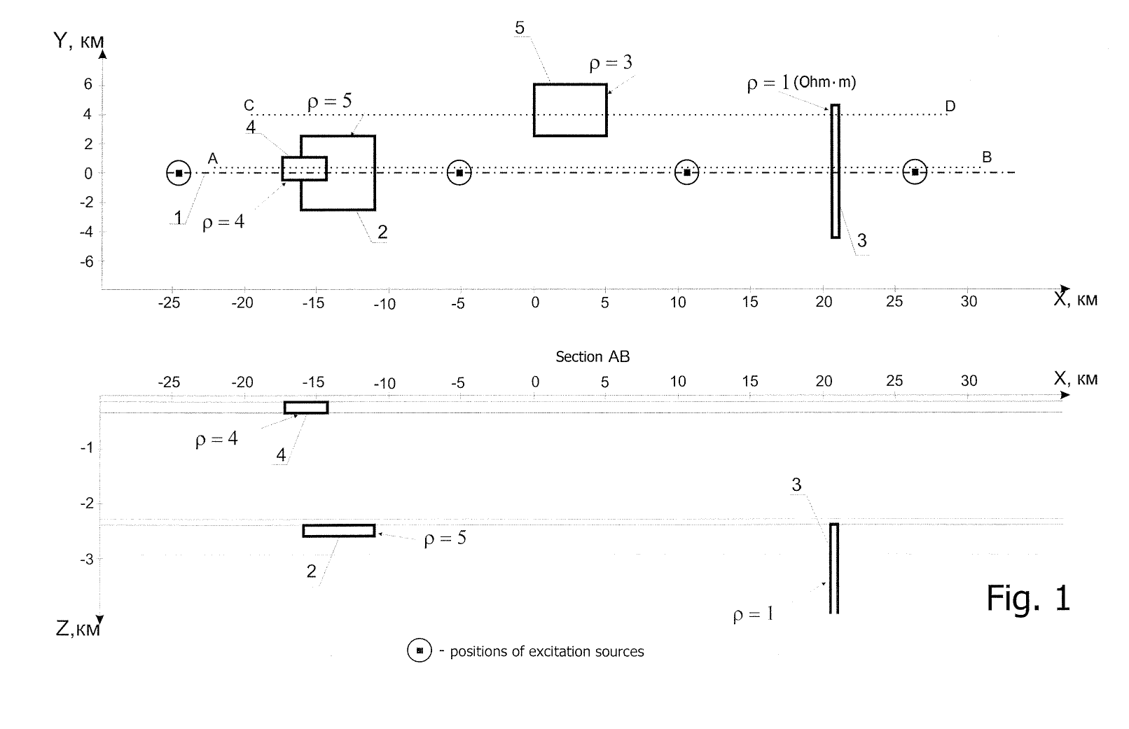

FIG. 1—Search geoelectrical mod in plane, the base observation system and cut along the line AB, which coincides with the base observation system;

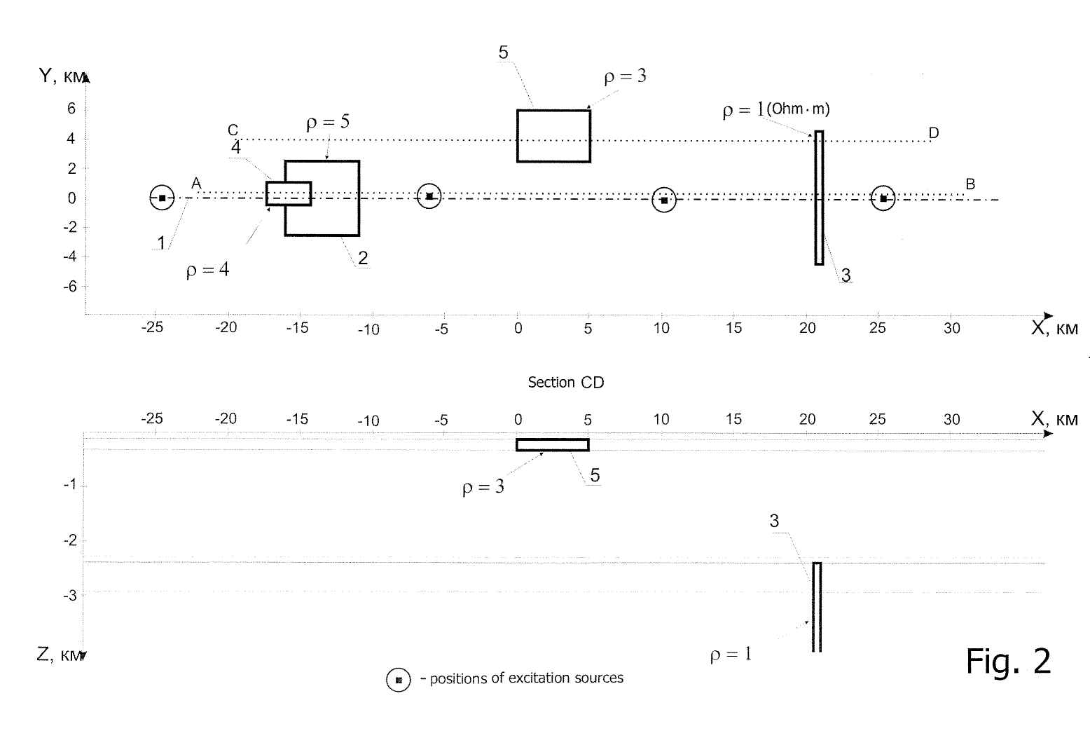

FIG. 2—Search geoelectrical model in plane, the basy observation system, and cut along the line CD parallel to the base observation system at a distance of 4 km;

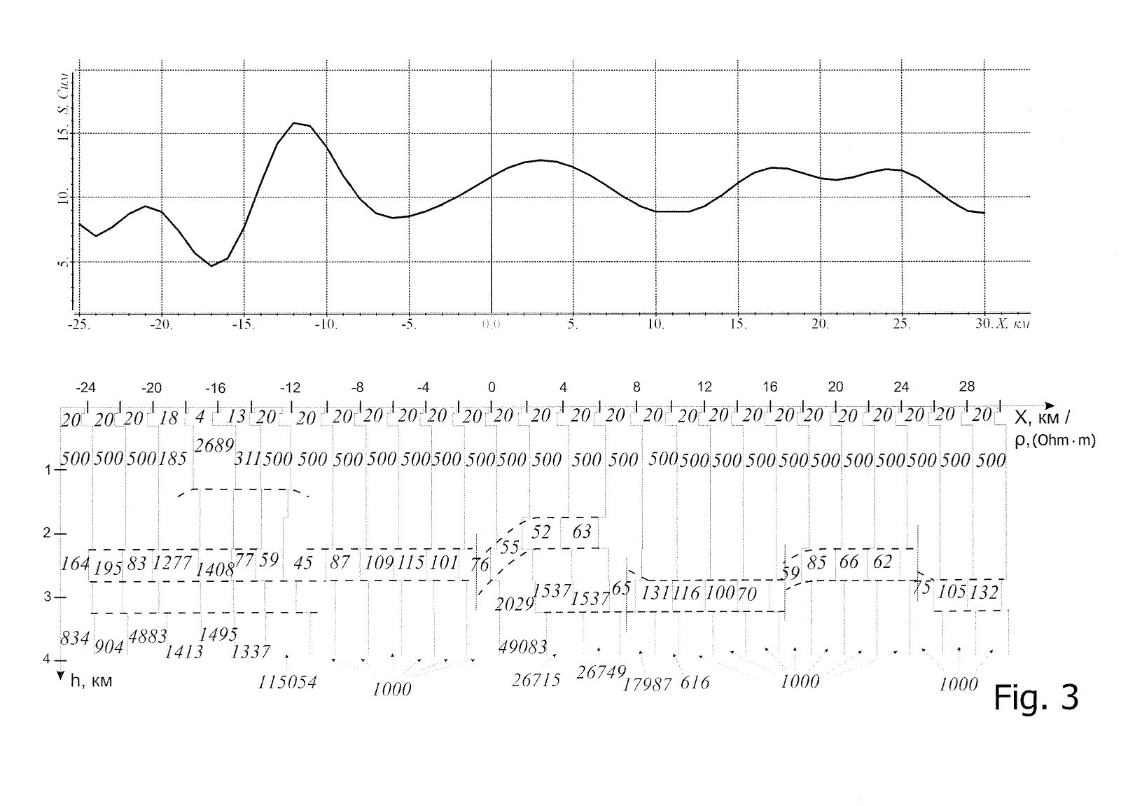

FIG. 3—1D inversion results for the measurements along the base observation system (FIG. 1-FIG. 2) and the graph of the total conductivity, which was generated on the results of 1D inversion;

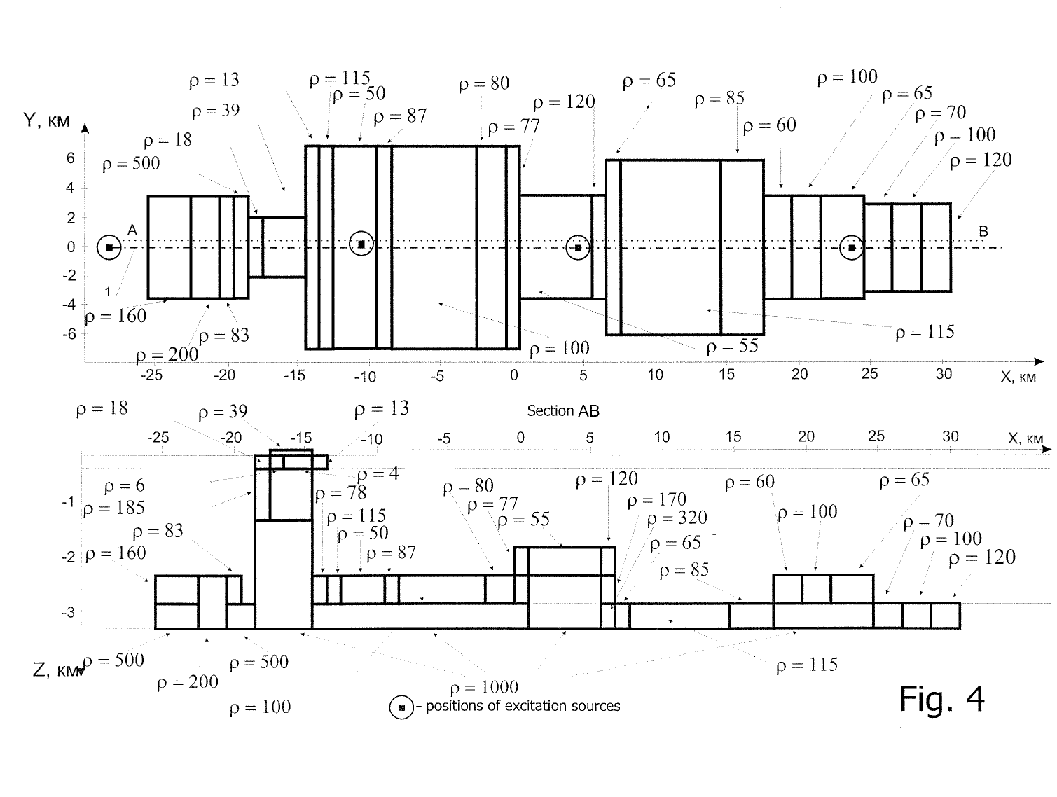

FIG. 4—Pre-3D model based on the results of 1D inversion (FIG. 3);

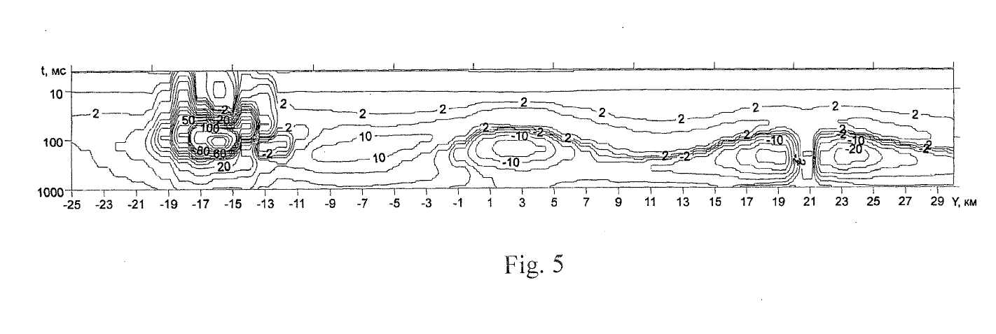

FIG. 5—mis-tie for pre-3D model generated on the results of 1D inversion (FIG. 4);

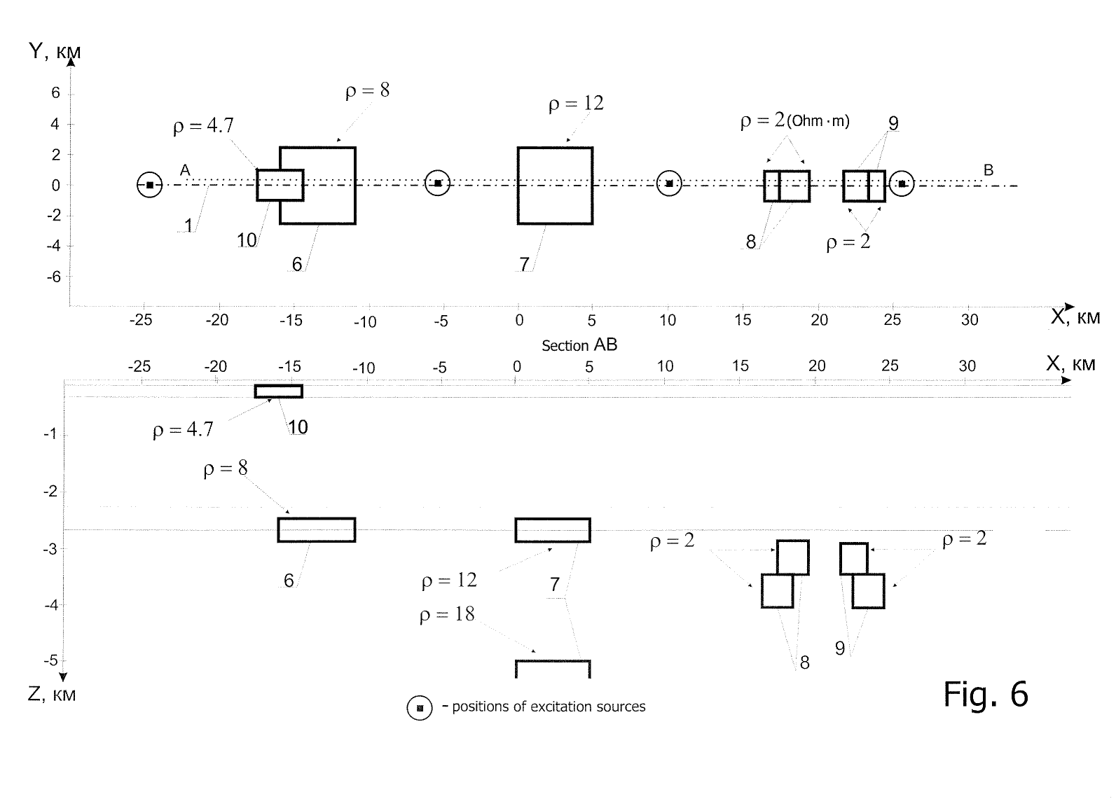

FIG. 6—Results of the primary 3D inversion along the base observation system;

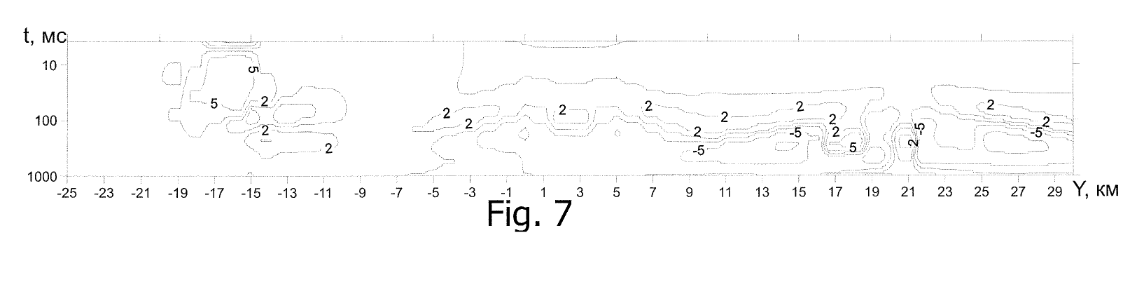

FIG. 7—mis-tie for the corrected 3D model generated as a result of the 3D inversion along the base observation system (FIG. 6);

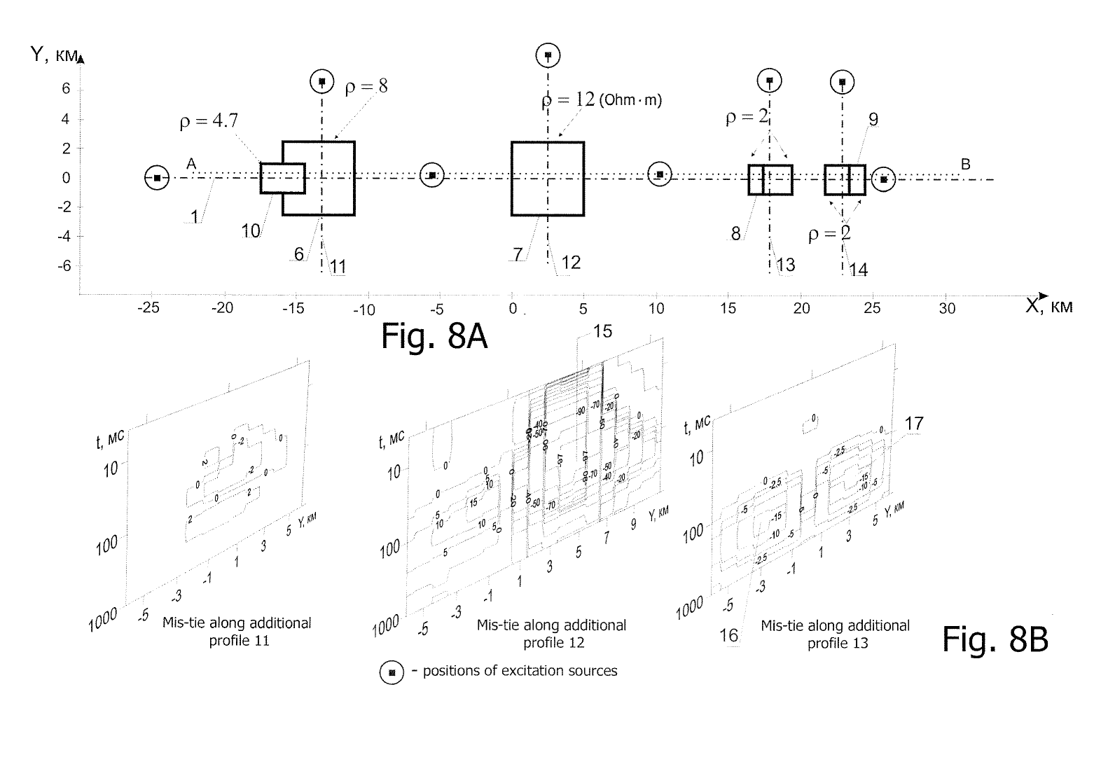

FIG. 8a—an observation system with additional measurements profiles 11-14;

FIG. 8b—mis-tie along said additional profiles for the corrected 3D model (FIG. 6) obtained as a result of primary 3D inversion;

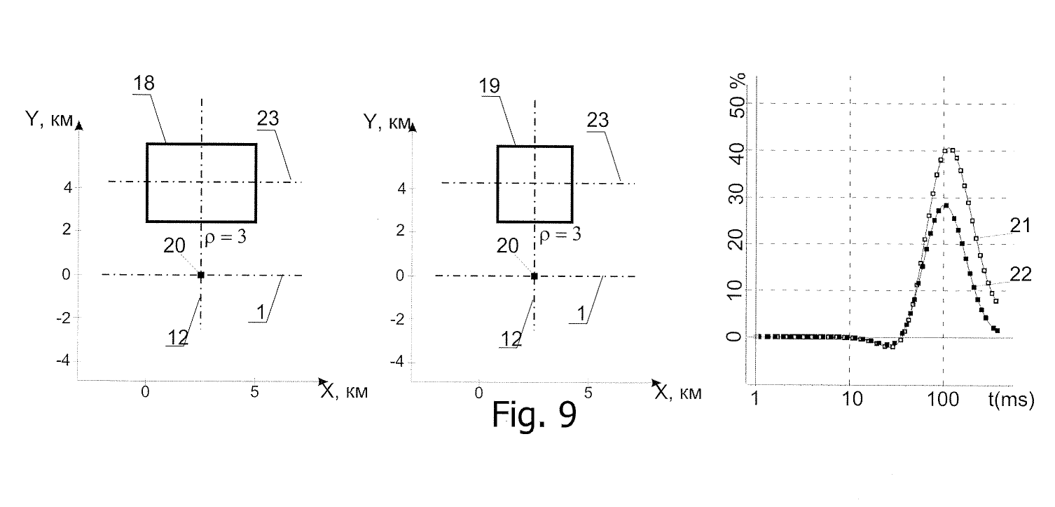

FIG. 9—effect of the transverse size of irregularities detected under the points of an additional profile 12 on the recorded signals at the points of the basic observation system, and the position of the following additional profile;

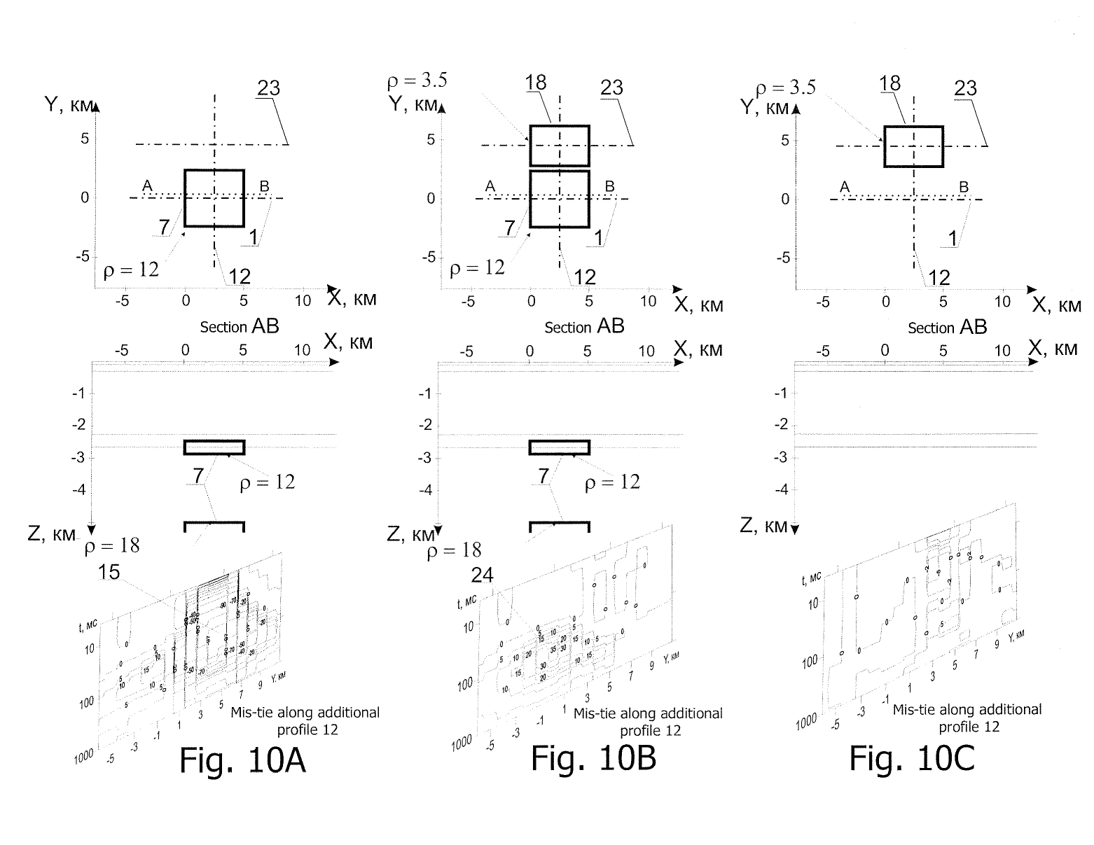

FIG. 10a-FIG. 10c—a mis-tie along the additional profile 12 for geoelectrical models obtained at different stages of operations and the inversion of the data;

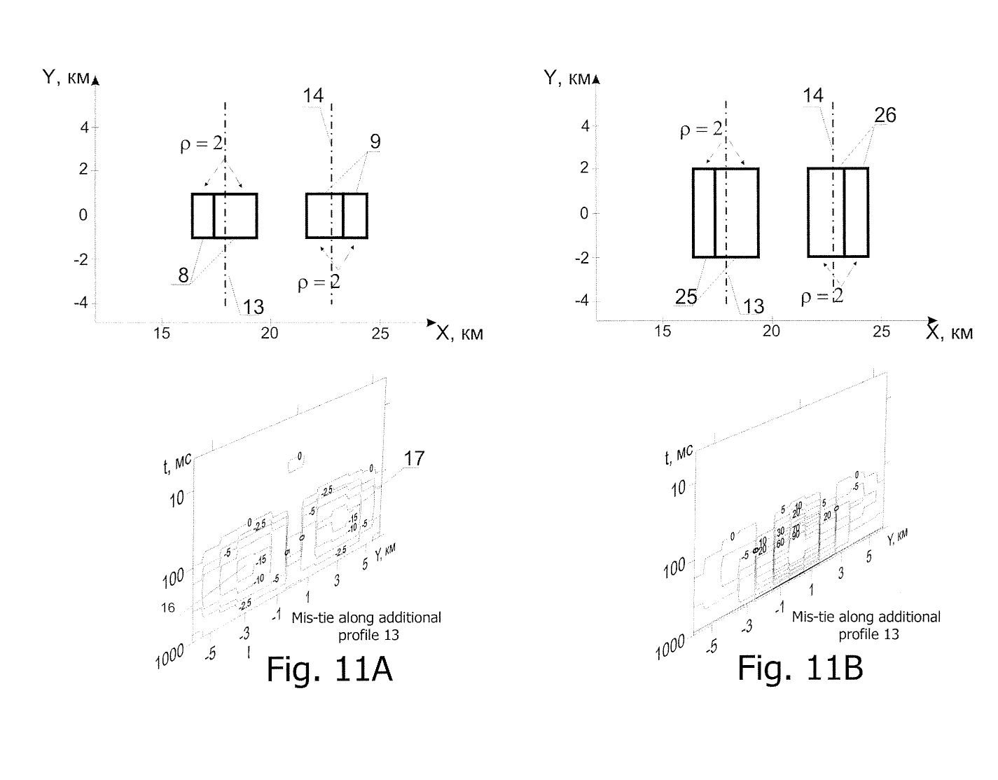

FIG. 11a-FIG. 11b—mis-tie along the additional profile 13 for geoelectrical models obtained at different stages of operations and the inversion of the data;

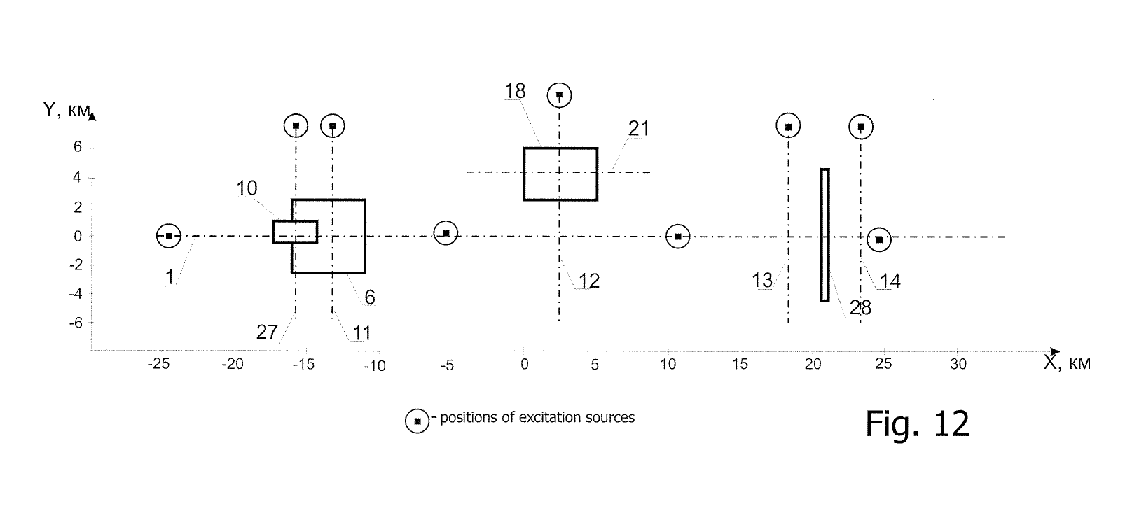

FIG. 12—the final observation system including the base observations system and all additional measurements.

The method according to the invention comprises the following sequence of operations.

1. An electromagnetic field is excited in the geological medium under study, and the system of receiving sensors is placed on the surface of the medium under study according to the basic observation system (FIG. 1, FIG. 2). The synchronous registration of the components of the electromagnetic field is caned out. The currents are excited in the geological medium using either a loop source, or a horizontal electric line, or a vertical electric line, or its analogs, or magnetotelluric currents. Receiving sensors can be either inductive or galvanically grounded (current line MN). Alternatively, multi-component field registration system can be used for measuring three components of the magnetic field and two horizontal components of the electric field. In this case, the excitation source and receiving sensors can be arranged in one plane or in different planes, i.e. at different levels in relation to the depth of the search object. The base observation system is a system of observations used at the initial stage of operations. Under the points of the base observation system the conductivity is required to be restored in a given target horizon. The base observation system can comprise a single profile (FIG. 1-FIG. 2), and can be profiled-areal or areal. Measurements in each point of the profile or the area can be either coaxial or multi-spaced along one direction, or multi-spaced in a few quasi-parallel or radial directions, or multi-spaced according to a regular observation network within the study area along several parallel or radial directions, or according to an arbitrary irregular network of observations. FIGS. 1-2 show an example of an exploration geoelectrical model. The steps of operations according to the invention based on synthetic data are further described. The exploration geoelectrical model with the points of the basic observation system 1 comprises an isometric target object 2, an elongated target object 3, an object-disturbance 4 under the points of the basic observation system, and an object-disturbance 5, which is lateral to the points of the base observation system.

2. For data obtained at the points of the base observation system, a primary 3D inversion is carried out to get a geoelectrical 3D model by the following sequence of operations:

2.1. 3D inversion is performed under each point of the base observation system (FIG. 3): the conductivity of the medium is determined under each measurement point by selecting in the frames of a horizontally layered model (for each source position independently of its other positions).

2.2. A preliminary 3D model is generated using “block-columns” under each point of the measurement results derived from the 1D-inversion. “Block-columns” under each point of measurement are a set of three-dimensional objects placed on top of each other and having the same size as the area of influence of the respective measurement point (determined by remote sounding and distances to neighboring points). Combining “block-columns” in a 3D model is carried out according to the criterion of proximity of the of layered media parameters (the resistivity and thickness of layers) in the neighboring “block-columns.” The resulting 3D model is shown in FIG. 4.

2.3. 3D calculation of the electromagnetic field based on the obtained preliminary geoelectrical model (FIG. 4) is performed. The resulting theoretical curves are compared with the measured data, and mis-tie (FIG. 5) is calculated.

2.4. False irregularities (conductivity anomalies) are deleted starting from certain depth (false irregularities are “block-columns”parts taken from the 3D inversion, said irregularities do not making a significant contribution to the registered signal).

2.5. Starting from certain depth, mostly isometric 3D objects are selected. They are, for example, in the shape of parallelepipedic irregularities with epicenters under the points of the basic observation system determining their depth, conductivity, and location in the plan, and a corrected 3D model is obtained, said model is shown in FIG. 6. The mis-tie calculated for said 3D model is shown in FIG. 7.

As a result of the described sequence of actions 2.1-2.5, the location of the conductivity abnormalities (significant changes in conductivity) is determined including the “apparent” anomalies (“apparent” conductivity anomalies are anomalies in the conductivity of the geoelectrical medium obtained as a result of the primary 3D inversion without accounting for influence of side objects) in the target horizons. In FIG. 6, these objects are marked as 6, 7, 8, and 9.

3. Additional measurements through the centers of the conductivity anomalies of 6, 7, 8, and 9 in the target horizon are taken. Additional measurements are the measurements along a profile orthogonal to the profile (or one of the profiles) in relation to which the measurements of the base observation system were taken. Additional measurements are taken until a conductivity anomaly selected under the points of the observation basic system, or until a conductivity anomaly selected under the points of the additional measurements is contoured in the other horizons. The profiles of additional measurements for the example are shown in FIG. 8a and marked as 11, 12, 13, and 14.

For the corrected 3D model selected using a basic observation system, a mis-tie is formed along the additional profiles (FIG. 8b). The level of the mis-tie confirms (or disproves) the existence of conductivity anomalies in the target horizon identified under the points of base observation system. If the level of the mis-tie along the additional profiles is sufficiently high as for the profiles 12, 13 and 14 (FIG. 8), a primary 3D inversion along these profiles is performed using a sequence of the actions 2.1-2.5.

If during the selection process along the additional profiles some irregularities are found, and they have a cross-sectional dimension which affects the times corresponding to the evidence of the targets objects in some of the points of the basic observation system or in some points of the additional measurements, the next step of additional measurements is performed through the centers of these irregularities until they are countered. In this example it is irregularity 18 or 19 (FIG. 9) which insertion in the model allows reducing the level of the mis-tie in region 15 (FIG. 8b) along additional profile 12 (FIG. 8a). The irregularities 18 or 19 in point 20 form anomalous fields 21 and 22, respectively. Thus, the transverse dimension of the irregularity (18 or 19) influences at times corresponding to the evidences of targets objects in the point 20 of the base observation system, and therefore for determining this dimension, additional profile 23 of measurements is formed (FIG. 9).

The irregularity 18 (FIG. 9) found during additional measurements along the additional profile 12 of a dimension corrected as a result of additional measurements along the additional profile 23 disproves the existence of irregularity 7 found along the base observation system before the additional measurements (FIG. 6). FIG. 10a shows the mis-tie of the corrected 3D model along the additional profile 12 before the selection of irregularity 18. FIG. 10b shows the mis-tie of the 3D model corrected for the second time along the additional profile 12 after the selection of the irregularity 18. The resulting high level of mis-tie in the field 24 indicates the redundancy of conductivity in this region, which corresponds to the position irregularity 7, thus disproving its actual existence. That is, the irregularity 7 identified under the points of the base system before the first measurements is proved to be false. The mis-tie of the 3D model corrected for the second time along the additional profile 12 after the selection of the irregularity 18 and deletion of the irregularity 7 is shown in FIG. 10c.

The presence of irregularities 8 and 9 identified along the base observation system before the first additional measurements is also rejected since it is impossible to select corresponding three-dimensional irregularities with identified centers (FIG. 11).in view of measurements along additional profiles 13 and 14.

The mis-ties shown in FIG. 11 prove that a significant level of mis-tie for isometric objects is observed in remote locations of the additional profiles 13 and 14 (FIG. 8a, regions 16 and 17, FIG. 8b, FIG. 11a). Extension of these objects (FIG. 11b, objects 25 and 26) along the additional profiles 13 and 14 allows reducing the level of the mis-tie in the remote points of additional profiles 13 and 14 but increasing the mis-tie in the central points. A detected anomaly (corresponding to an elongated object) can be parameterized as a result of complete 3D inversion according to the algorithm described below.

The presence of irregularity 6 (FIG. 6) is confirmed by a low level of the mis-tie along the profile of an additional profile 11 (FIG. 8a, FIG. 8b). A more accurate parameterization can be performed after correction of irregularity 10 parameters (FIG. 6) using an additional profile 22 (FIG. 12). FIG. 12 shows the resulting observation system consisting of the points of basic observation system and additional measurements.

5. Based on the data obtained by the base observation system and the data obtained by all additional measurements, the final 3D inversion is performed according to the following algorithm:
selecting a normal field (the field of an average host horizontally-layered medium, which in the course of the 3D inversion receives three-dimensional irregularities) according to the maximum similarity of will be placed) on the maximum similarity for all layering for all separations;
forming anomalous fields (mis-ties) for each of the sources;
selecting main irregularities in near-surface parts of the cross-section consistently for all sources;
correcting the result by inclusion of smaller objects;
forming anomalous fields and localization of weaker anomalies of the underlying objects;

All these stages of the 3D inversion associated with the 3D calculations are performed using the finite element 3D modeling (precision, error at most 1-2% over the whole time range of signal recording).

The final 3D inversion in this case is selection of three-dimensional geoelectrical model, which is the same for all points of measurement, that is, the three-dimensional geoelectrical model according to the above-described sequence of actions and said algorithm formed under the condition of simultaneous coincidence of all measured and calculated values of the electromagnetic field components. At the same time in obtaining the calculated values at all points of measurements, a single geoelectrical model is used.

As a result of the final 3D inversion according to the adaptive observation system (FIG. 12), a final geoelectrical 3D model (FIG. 12) of the observed medium is produced. The geometrical parameters, conductivity and positions of conductivity anomalies in the target horizon are obtained based on the model.

The method according to the invention has the claimed scope of essential features. Due to the procedures for additional measurements and 3D inversion, the method provides for rejection of possible false conductivity anomalies in the target horizons along the base observation system. That in its turn provides a highly accurate 3D geoelectrical model, increases the accuracy of the conductivity anomaly parameters, and ultimately improves the accuracy of the geophysical prediction.

1. A method of geoelectrical prospecting, said method comprising:
exciting electromagnetic field in a geological medium;
registering synchronously the electromagnetic field components by receiving sensors;
determining conductivity of the surveying geological medium;
comparing measured and calculated data of the electromagnetic field components including forming geoelectrical model of the observed medium;
conducting additional measurements in view of the results of said comparison; characterized in that
the comparison of the measured and calculated data of secondary electromagnetic field components including forming geoelectrical model of the observed medium is conducted by comparing the 3D model for which 3D calculation is made, and a mis-tie in the relation to the measured data is calculated for excluding false conductivity anomalies and selecting 3D objects with epicenters under the points of the base observing system;
based on the obtained corrected 3D model, the positions of conductivity anomalies in target horizon are determined;
then said additional measurements are conducted along the profiles passing through the centers of said conductivity anomalies;
results of said measurements are used for determining a mis-tie for said additional profiles of said corrected 3D model which is corrected according to the level of the obtained mis-tie;
as a result, the presence of conductivity anomalies in the target horizon is either confirmed or rejected;
after that the parameters of all detected conductivity anomalies are determined using base observation system data as well as additional measurements data substantially effecting the times of target objects development in the points of the base observation system or in the points of additional measurements;
estimating lateral dimension of said conductivity anomalies, and in the case of substantial effect on times corresponding to the target object evidence in the points of the base observation system and/or in the points of additional observation system, measuring for additional profiles passing through the centers of said conductivity anomalies;
after that performing 3D inversion using data of the obtained observation system including the base system and obtained additional measurement profiles, and according to the results of said inversion, determining geometrical parameters, conductivity and location of conductivity anomalies in the whole horizon.

2. The method according to claim 1, characterized in that all said additional measurements are carried out until conductivity anomalies in the target horizon selected under the points of the basic observation system are contoured or until conductivity anomalies in the upper horizons in relation to the target horizon, selected under the points of conducted corresponding additional measurements, are countered.

3. The method according to claim 1, characterized in that the additional measurements are carried out with receiving sensors changing positions but exciting sources not changing their positions.

4. The method according to claim 1, characterized in that the additional measurements are carried out with both receiving and exciting sources changing their positions.

5. The method according to claim 1, characterized in that the basic observation system is a profile one with the coaxial soundings or an areal one with the coaxial soundings.

6. The method according to claim 1, characterized in that the basic observation system is a profile one with multi-spaced soundings along one direction or a profile-areal one in a few quasi-orthogonal directions or along a few parallel or radial directions.

7. The method according to claim 1, characterized in that the basic observation system is an areal one with multi-spaced soundings according to a regular observation network within the observed area along a few parallel or radial directions, or according to an arbitrary irregular observation network.

8. The method according to claim 1, characterized in that excitation is conducted by a loop source, and the measurements are conducted by induction receiving sensors, wherein the exciting source and the receiving sensors are located either in one plane or as well as in planes being at different heights in relation to the depth of the searched object.

9. The method according to claim 1, characterized in that the exciting source is in the form of a galvanically earthed horizontal line, and the measurements are conducted by galvanically earthed lines co-directed to the exciting source.

10. The method according to claim 1, characterized in that the exciting source is in the form of a vertical electrical line or its analogs, wherein the measurements are conducted using either induction receiving sensors or galvanically earthed lines.

11. The method according to claim 1, characterized in that the exciting source is a loop source or a source in the form of a galvanically earthed horizontal line or its analogs, wherein three components of the magnetic field and two horizontal components of the electric field are measured.

12. The method according to claim 1, characterized in that it comprises measurements of magnetotelluric field of Earth by measuring three components of the magnetic field and two horizontal components of the electric field.
